(19) United States
(12) Patent Application Publication
(10) Pub. No.: US 2019/0114202 A1
(43) Pub. Date: Apr. 18, 2019

(54) TASK SCHEDULING METHOD AND APPARATUS OF ARTIFICIAL INTELLIGENCE HETEROGENEOUS HARDWARE, DEVICE AND READABLE MEDIUM

(71) Applicant: BEIJING BAIDU NETCOM SCIENCE AND TECHNOLOGY CO., LTD., Beijing (CN)

(72) Inventors: Yong WANG, Beijing (CN); Jian OUYANG, Beijing (CN); Wei QI, Beijing (CN)

(21) Appl. No.: 16/159,322

(22) Filed: Oct. 12, 2018

(30) Foreign Application Priority Data
Oct. 13, 2017 (CN) 2017109527358

(51) Int. Cl. G06F 9/48; G06F 9/50

(52) U.S. Cl. CPC G06F 9/4837; G06F 9/485; G06F 9/5044; G06F 9/4881

(57) ABSTRACT

The present disclosure provides a task scheduling method and apparatus of artificial intelligence heterogeneous hardware, a device and a readable medium. The method comprises: receiving a task execution request for a corresponding function sent from an API, the task execution request carrying attribute information of the task; obtaining a priority of the task according to attribute information of the task, wherein a priority of an online service is higher than a priority of an offline task; inserting the corresponding task into a scheduling queue of a corresponding function according to the priority of the task; tasks in the scheduling queue being arranged in a descending order of priorities; controlling in turn a free computing unit in a plurality of computing units of the corresponding function to execute the corresponding task, in the descending order of priorities of the task in the scheduling queue. According to the technical solution of the present embodiment, it is feasible to achieve mixed performance of the offline model training task and online reasoning service according to the difference of priorities, thereby substantially improving the resource utilization rate.

The present application claims priority of Chinese Patent Application No. 201710952735.8, filed on Oct. 13, 2017, with the title of “Task scheduling method and apparatus of artificial intelligence heterogeneous hardware, device and readable medium”. The disclosure of the above applications is incorporated herein by reference in its entirety.

### FIELD OF THE DISCLOSURE

The present disclosure relates to the technical field of computer application, and particularly to a task scheduling method and apparatus of artificial intelligence heterogeneous hardware, a device and a readable medium.

### BACKGROUND OF THE DISCLOSURE

Artificial intelligence (AI) is already extensively applied to various fields. Particularly, deep learning as a typical new method in recent years achieves the state-of-the-art effect in many fields such as speech recognition, image recognition, Click-Through-Rate (CTR) and natural language processing.

Current main methods of the AI technologies are machine learning and deep learning, and mainly comprise model training and model reasoning. Model training mainly relates to training a model from historical data first, and then using the model to perform online reasoning in the model reasoning phase. Due to performance, a lot of AI heterogeneous hardware is applied in the model training and model reasoning. The model training is an offline task, mainly cares about throughput, does not have a high requirement for time delay, and therefore exhibits a high resource utilization rate. The model reasoning is online service, needs to meet certain time delay requirements, and allocates resources according to a peak. However, the current AI heterogeneous hardware, upon receiving a task, does not distinguish whether the task is online service or offline task, but sequentially executes the task according to a sequential order of time of receiving the task.

Based on the above statements, it is very difficult for the current AI heterogeneous hardware to achieve virtualization, impossible to achieve resource isolation, and impossible to improve a resource utilization rate by performing the offline task and online service in a mixed manner, so the resource utilization rate is very low.

### SUMMARY OF THE DISCLOSURE

The present disclosure provides a task scheduling method and apparatus of artificial intelligence heterogeneous hardware, a device and a readable medium, to improve the resource utilization rate of the AI heterogeneous hardware upon task scheduling.

The present disclosure provides a task scheduling method of artificial intelligence heterogeneous hardware, the method comprising:

receiving a task execution request for a corresponding function sent from an application program interface, the task execution request carrying attribute information of the task;

obtaining a priority of the task according to attribute information of the task, wherein a priority of an online service is higher than a priority of an offline task;

inserting the corresponding task into a scheduling queue of a corresponding function according to the priority of the task; tasks in the scheduling queue being arranged in a descending order of priorities;

controlling in turn a free computing unit in a plurality of computing units of the corresponding function to execute the corresponding task, in the descending order of priorities of the task in the scheduling queue;

Further optionally, in the method, the attribute information of the task comprises a priority of the task, and the priority of the task is assigned for the task by a scheduling module at an upper layer of the application program interface.

Further optionally, in the method, the obtaining a priority of the task according to attribute information of the task specifically comprises:

setting a priority for the task according to a pre-stored priority setting policy and the attribute information of the task.

Further optionally, in the method, the attribute information of the task comprises a type of the task, and the type of the task is an offline task or online service; the priority setting policy comprises setting the priority of the task according to the type of task;

the setting a priority for the task according to a pre-stored priority setting policy and the attribute information of the task specifically comprises:

obtaining the type of the task from the attribute information of the task;

setting a priority for the task according to the type of the task, so that the priority of the task corresponding to the online service is higher than the priority of the task corresponding to the offline task.

Further optionally, in the method, the attribute information of the task comprises a type of the task and a class in the type, and the type of the task is an offline task or online service; the priority setting policy comprises setting the priority for the task according to the type of the task, the class in the type and a preset high priority class list corresponding to the preset types;

the setting a priority for the task according to a pre-stored priority setting policy and the attribute information of the task specifically comprises:

obtaining the type of the task and the class in the type from the attribute information of the task;

setting the priority for the task according to the type of the task, the class in the type and the preset high priority class list corresponding to the preset types; wherein the priority of the task corresponding to the online service is higher than the priority of the task corresponding to the offline task; and, in the same type, the priorities of tasks corresponding to classes in the high priority class list are higher than priorities of tasks corresponding to classes outside the high priority class list.

Further optionally, in the method, the attribute information of the task comprises a preset finishing time instant of the task; the priority setting policy comprises setting the priority of the task according to a distance between the preset finishing time instant of the task and a current time instant;

the setting a priority for the task according to a pre-stored priority setting policy and the attribute information of the task specifically comprises:

obtaining the preset finishing time instant of the task from the attribute information of the task;

calculating a time difference between the preset finishing time instant of the task and the current time instant;

setting a priority for the task according to the time difference, so that the priority of the task corresponding to the time difference which is smaller than a first preset time length threshold is higher than the priority of the task corresponding to the time difference which is larger than the first preset time length threshold and smaller than or equal to a second preset time length threshold, and the priority of the task corresponding to the time difference which is larger than the first preset time length threshold and smaller than or equal to the second preset time length threshold is higher than the priority of the task corresponding to the time difference which is larger than the second preset time length threshold.

The present disclosure provides a task scheduling apparatus of AI heterogeneous hardware, the apparatus comprising:

a receiving module configured to receive a task execution request for corresponding function sent from an application program interface, the task execution request carrying attribute information of the task;

an obtaining module configured to obtain a priority of the task according to attribute information of the task, wherein a priority of an online service is higher than a priority of an offline task;

an inserting module configured to insert a corresponding task into a scheduling queue of a corresponding function according to the priority of the task; tasks in the scheduling queue being arranged in a descending order of priorities;

a controlling module configured to control in turn a free computing unit in a plurality of computing units of the corresponding function to execute the corresponding task, in the descending order of priorities of the task in the scheduling queue;

the scheduling queue being used to store tasks of the corresponding function in the descending order of priorities.

Further optionally, in the apparatus, the attribute information of the task comprises a priority of the task, and the priority of the task is assigned for the task by a scheduling module at an upper layer of the application program interface.

Further optionally, in the apparatus, the obtaining module is specifically configured to set a priority for the task according to a pre-stored priority setting policy and the attribute information of the task.

Further optionally, in the apparatus, the attribute information of the task comprises a type of the task, and the type of the task is an offline task or online service; the priority setting policy comprises setting the priority of the task according to the type of task;

the obtaining module specifically comprises:

an obtaining unit configured to obtain the type of the task from the attribute information of the task;

a setting unit configured to set a priority for the task according to the type of the task, so that the priority of the task corresponding to the online service is higher than the priority of the task corresponding to the offline task.

Further optionally, in the apparatus, if the attribute information of the task comprises a type of the task and a class in the type, and the type of the task is an offline task or online service; the priority setting policy comprises setting the priority for the task according to the type of the task, the class in the type and a preset high priority class list corresponding to the preset types;

the obtaining unit is specifically configured to obtain the type of the task and the class in the type from the attribute information of the task;

the setting unit is specifically configured to set the priority for the task according to the type of the task, the class in the type and the preset high priority class list corresponding to the preset types; wherein the priority of the task corresponding to the online service is higher than the priority of the task corresponding to the offline task; and, in the same type, the priorities of tasks corresponding to classes in the high priority class list are higher than priorities of tasks corresponding to classes outside the high priority class list.

Further optionally, in the apparatus, if the attribute information of the task comprises a preset finishing time instant of the task; the priority setting policy comprises setting the priority of the task according to a distance between the preset finishing time instant of the task and a current time instant;

the obtaining unit is specifically configured to obtain the preset finishing time instant of the task from the attribute information of the task;

the setting unit is specifically configured to calculate a time difference between the preset finishing time instant of the task and the current time instant; set a priority for the task according to the time difference, so that the priority of the task corresponding to the time difference which is smaller than a first preset time length threshold is higher than the priority of the task corresponding to the time difference which is larger than the first preset time length threshold and smaller than or equal to a second preset time length threshold, and the priority of the task corresponding to the time difference which is larger than the first preset time length threshold and smaller than or equal to the second preset time length threshold is higher than the priority of the task corresponding to the time difference which is larger than the second preset time length threshold.

The present disclosure further provides a computer device, comprising:

one or more processors,

a memory for storing one or more programs,

the one or more programs, when executed by said one or more processors, enable said one or more processors to implement the task scheduling method of the AI heterogeneous hardware.

The present disclosure further provides a computer readable medium on which a computer program is stored, the program, when executed by the processor, implementing the task scheduling method of the AI heterogeneous hardware.

According to the task scheduling method and apparatus of artificial intelligence heterogeneous hardware, the device and the readable medium of the present disclosure, it is feasible to receive a task execution request for a corresponding function sent from an API, the task execution request carrying attribute information of the task; obtain a priority of a task according to attribute information of the task, wherein a priority of an online service is higher than a priority of an offline task; insert a corresponding task into a scheduling queue of a corresponding function according to the priority of the task; tasks in the scheduling queue being arranged in a descending order of priorities; controlling in turn a free computing unit in the plurality of computing units of the corresponding function to execute the corresponding task, in the descending order of priorities of tasks in the scheduling queue. According to the technical solution of the present embodiment, it is feasible to achieve mixing of the offline model training task and online reasoning service according to the difference of priorities, and it is also feasible to achieve the scheduling of different online reasoning services in the descending order of priorities, and the scheduling of different offline model training tasks also in the descending order of priorities, thereby substantially improving the resource utilization rate.

### BRIEF DESCRIPTION OF DRAWINGS

FIG. 1 is a flow chart of an embodiment of a task scheduling method of AI heterogeneous hardware according to the present disclosure.

FIG. 2 is a diagram of an example of inserting a task into a scheduling queue of a corresponding function according to the present disclosure.

FIG. 3 is a diagram of another example of inserting a task into a scheduling queue of a corresponding function according to the present disclosure.

FIG. 4 is a diagram of architecture of task scheduling processing of AI heterogeneous hardware according to the present disclosure.

FIG. 5 is a structural diagram of Embodiment 1 of a task scheduling apparatus of AI heterogeneous hardware according to the present disclosure.

FIG. 6 is a structural diagram of Embodiment 2 of a task scheduling apparatus of AI heterogeneous hardware according to the present disclosure.

FIG. 7 is a block diagram of an embodiment of a computer device according to the present disclosure.

FIG. 8 is an example diagram of a computer device according to an embodiment of the present disclosure.

### DETAILED DESCRIPTION OF PREFERRED EMBODIMENTS

The present disclosure will be described in detail in conjunction with figures and specific embodiments to make objectives, technical solutions and advantages of the present disclosure more apparent.

FIG. 1 is a flow chart of an embodiment of a task scheduling method of AI heterogeneous hardware according to the present disclosure. As shown in FIG. 1, the task scheduling method of AI heterogeneous hardware according to the present embodiment may specifically comprise the following steps:

100: receive a task execution request for a corresponding function sent from an API, the task execution request carrying attribute information of the task;

A subject for executing the task scheduling method of AI heterogeneous hardware according to the present embodiment is a task scheduling method of AI heterogeneous hardware, and the task scheduling apparatus of AI heterogeneous hardware may be disposed in a drive of the AI heterogeneous hardware. The AI heterogeneous hardware in the present embodiment may comprise a Field-Programmable Gate Array (FPGA) or Application Specific Integrated Circuits (ASIC). The current FPGA or ASIC processing AI can only sequentially perform task scheduling according to a time sequence of receiving tasks, cannot achieve resource isolation, and cannot improve the resource utilization rate by performing the offline task and online service in a mixed manner. For example, an actual average utilization rate of Baidu's tens of thousands of AI online reasoning clusters is only about 10%. Based on this problem, the present disclosure provides the technical solution of the present embodiment to achieve resource isolation through different priorities of the tasks, and achieve the mixed performance of the offline task and online service, thereby substantially improving the resource utilization rate.

In the present embodiment, the task scheduling apparatus of the AI heterogeneous hardware receives a task execution request for a corresponding function sent from an API, the task execution request carrying attribute information of the task. Each API receives a task execution request for a corresponding function.

In a first case of the attribute information of the task, optionally, the attribute information of the task in the task execution request may include a priority of the task, whereupon the priority of the corresponding task may be set by a scheduling module at an upper layer of API for the task. Upon setting the priority for the task, the scheduling module of the upper layer of the API may employ various priority setting policies.

For example, the scheduling module may set a priority of the task according to the type of the task. The type of the task may be offline task or online service. The offline task may specifically be the model training task in the AI processing. The online service may specifically be the online reasoning service in AI processing. When the priority is set, since the online service has a higher requirement for time delay, the priority of the task corresponding to the online service is set higher than the priority of the task corresponding to the offline task. In this manner, all tasks can only be set with two priorities

Or the scheduling module may further set more priorities, for example, the scheduling module may set the priority of the task according to the type of the task, a class in the type and a preset high priority class list in all types. Likewise, at this time, the type of the corresponding task is also the offline task or online service. In the present embodiment, tasks corresponding to the offline task may further be divided into high-priority tasks and low-priority tasks, and tasks corresponding to the online service may be further divided into high-priority tasks and low-priority tasks. For example, it is feasible to respectively set a high priority class list of the offline task and the online service, as a white list of classes of high priorities of the offline task and online service. For example, among tasks corresponding to the online service type, tasks corresponding to classes belonging to the high priority class list of the online service are set as having the highest priority, for example, level 4, whereas among the tasks corresponding to the online service type, tasks corresponding to classes not belonging to the high priority class list of the online service are set as having a higher priority, for example, level 3, wherein level-3 priority is lower than level-4 priority. Among tasks corresponding to the offline type of the task, tasks corresponding to classes belonging to the high priority class list of the offline task are set as having a high priority, for example, level 2, wherein level-2 priority is lower than level-3 priority, namely, the high priority of the offline task is lower than the low priority of the online service. Among the tasks corresponding to the offline type of the task, tasks corresponding to classes not belonging to the high priority class list of the offline task are set as having a low priority, for example, level 1, wherein level-1 priority is lower than level-2 priority. In addition, it is feasible to merge priorities of tasks corresponding to classes not belonging to the high priority class list of the online services among the tasks corresponding to the online service type and priorities of tasks corresponding to classes belonging to the high priority class list of the offline task among the tasks corresponding to the offline type of the task into a priority such as NORMAL. It is feasible to set tasks corresponding to classes belonging to the high priority class list of the online service among tasks corresponding to the online service type as having the highest priority for example HIGH, and set tasks corresponding to classes not belonging to the high priority class list of the offline task among tasks corresponding to the offline type of the task as having the lowest priority for example LOW. The priority of HIGH is the highest, the priority of LOW is the lowest, and the priority of NORMAL is between HIGH and LOW.

Again for example, the scheduling module may further set the priority of the task according to a distance between a preset finishing time instant of the task and a current time instant. In the present embodiment, the preset finishing time instant of the task refers to an expected finishing time instant of execution of the task. If the preset finishing time instant of the task is closer to the current time instant, this indicates that the task needs to be completed more urgently, whereupon the priority set for the task may be higher; if the preset finishing time instant of the task is farther away from the current time instant, this indicates that the task needn't be completed urgently, and may be completed in sufficient time, whereupon the priority set for the task may be lower.

In practical application, policies employed by the scheduling module to set the priorities of tasks are not limited to the abovementioned policies. It is further possible to set priorities of tasks in other user-set policy manners, which are not detailed one by one.

In a second case of the attribute information of the task, optionally, the attribute information of the task in the present embodiment may further comprise other information of tasks such as type of the task, or may further comprise type of the task as well as a class in the type, or may further comprise other attribute information such as the preset finishing time instant of the task. As such, the task scheduling apparatus of the AI heterogeneous hardware may be preset with a priority setting policy so that the task scheduling apparatus of the AI heterogeneous hardware obtains the priority of the task according to the attribute information of the task. For particulars, please refer to depictions of the following steps.

101: obtaining a priority of a task according to attribute information of the task, wherein a priority of online service is higher than a priority of an offline task;

In practical application, the online service such as AI online reasoning service has a higher requirement for time delay, whereas the offline task such as AI model training task has a lower requirement for time delay. Therefore, in the present embodiment, the priority of the online service in the priority of the task obtained according to the attribute information of the task is higher than the priority of the offline task.

Corresponding to the above first case of the attribute information of the task, step 101 at this time may relate to directly obtaining the priority of the task from the attribute information of the task. The priority of the task may specifically be identified by a number 1, 2, 3 or 4, or identified using HIGH, NORMAL and LOW. For particulars, please refer to the above depictions of the first case of the attribute information of the task. No details are presented any more here.

Corresponding to the above second case of the attribute information of the task, step 101 at this time may specifically comprise the following step: setting a priority for the task according to a pre-stored priority setting policy and the attribute information of the task.

That is to say, regarding the above second case of the attribute information of the task, it is necessary to pre-store a priority setting policy in the task scheduling apparatus of the AI heterogeneous hardware, to limit the task scheduling apparatus of the AI heterogeneous hardware to set a priority for the task corresponding to a task execution request, according to the priority setting policy and the attribute information of the task carried in the task execution request.

Below are described several cases of setting the priority for the task according to the pre-stored priority setting policy and the attribute information of the task:

Case a): if in the above second case of the attribute information of the task, the attribute information of the task comprises a type of the task which is offline task or online service; the pre-stored priority setting policy in the task scheduling apparatus of the AI heterogeneous hardware is setting the priority for the task according to the type of the task; at this time, correspondingly, priorities of all tasks are only divided into two levels, namely, high priority of the online service and low priority of the offline task. For example, it is feasible to only set two priorities HIGH and LOW.

At this time, correspondingly “setting a priority for the task according to a pre-stored priority setting policy and the attribute information of the task” may specifically comprise: obtaining a type of the task from the attribute information of the task; setting a priority for the task according to the type of the task, so that the priority of the task corresponding to the online service is higher than the priority of the task corresponding to the offline task. For example, if the type of the task is determined as the online service, the priority of the task is set as HIGH, whereas when the type of the task is offline task, the priority of the task is set as LOW. As such, it is possible to ensure that the priority of the task corresponding to the online service is higher than the priority of the task corresponding to the offline task.

Case b): if in the above second case of the attribute information of the task, the attribute information of the task comprises a type of the task and a class in the type, and the type of the task is offline task or online service; the pre-stored priority setting policy in the task scheduling apparatus of the AI heterogeneous hardware is setting the priority for the task according to the type of the task, the class in the type and a high priority class list corresponding to the preset types.

At this time, correspondingly “setting a priority for the task according to a pre-stored priority setting policy and the attribute information of the task” may specifically comprise: obtaining a type of the task from the attribute information of the task and the class in the type; setting the priority for the task according to the type of the task, the class in the type and a high priority class list corresponding to the preset types; wherein the priority of the task corresponding to the online service is higher than the priority of the task corresponding to the offline task; and, in the same type, the priorities of tasks corresponding to classes in the high priority class list are higher than priorities of tasks corresponding to classes outside the high priority class list. In the technical solution of the present embodiment, the high priority class list corresponding to each type may be a white list of classes of the high priority corresponding to the type. For particulars, please refer to the depictions of the above relevant embodiments. As such, according to the technical solution of the present embodiment, priorities of tasks corresponding to the online service may comprise two types, for example, the highest priority 4, and higher priority 3 lower than the highest priority 4 respectively. The priorities of tasks corresponding to the offline task may comprise two types: for example, high priority 2 and low priority 1 which is lower than the high priority 2, wherein the priority 2 is lower than the priority 3, namely, the high priority of the offline task is also lower than the low priority of the online service. Likewise, it is feasible to merge priorities of tasks corresponding to classes not belonging to the high priority class list of the online services among the tasks corresponding to the online service type and priorities of tasks corresponding to classes belonging to the high priority class list of the offline task among the tasks corresponding to the offline type of the task into a priority such as NORMAL. It is feasible to set tasks corresponding to classes belonging to the high priority class list of the online service among tasks corresponding to the online service type as having the highest priority for example HIGH, and set tasks corresponding to classes not belonging to the high priority class list of the offline task among tasks corresponding to the offline type of the task as having the lowest priority for example LOW. The priority of HIGH is the highest, the priority of LOW is the lowest, and the priority of NORMAL is between HIGH and LOW. For particulars, please refer to the depictions of the above relevant technical solution. In AI, it is feasible to use this solution to achieve online reasoning service of different classes, and use different priorities for scheduling; it is also feasible to implement offline model training task of different classes, and use different priorities for scheduling.

Case c): if in the above second case of the attribute information of the task, the attribute information of the task comprises a preset finishing time instant of the task; the pre-stored priority setting policy in the task scheduling apparatus of the AI heterogeneous hardware is setting the priority of the task according to a distance between a preset finishing time instant of the task and a current time instant;

At this time, correspondingly “setting a priority for the task according to a pre-stored priority setting policy and the attribute information of the task” may specifically comprise: obtaining the preset finishing time instant of the task from the attribute information of the task; calculating a time difference between the preset finishing time instant of the task and the current time instant; setting a priority for the task according to the time difference, so that the priority of the task corresponding to the time difference which is smaller than a first preset time length threshold is higher than the priority of the task corresponding to the time difference which is larger than the first preset time length threshold and smaller than or equal to a second preset time length threshold, and the priority of the task corresponding to the time difference which is larger than the first preset time length threshold and smaller than or equal to the second preset time length threshold is higher than the priority of the task corresponding to the time difference which is larger than the second preset time length threshold.

In the present embodiment, an example is taken in which tasks are classified as having three priorities according to the time difference between the preset finishing time instant of the task and the current time instant, namely, the priority of the task corresponding to the time difference which is smaller than the first preset time length threshold is the highest, the priority of the task corresponding to the time difference which is larger than the second preset time length threshold is the lowest, and the priority of the task corresponding to the time difference which is larger than the first preset time length threshold and smaller than or equal to the second preset time length threshold is between the foregoing two priorities. In practical application, it is also possible to set two or more priorities according to the time difference in the similar manner, which will not be detailed one by one here.

It needs to be appreciated that the above case c) is only adapted for the situation in which the type of the task is processing an offline task for example AI offline model training task because only the offline task has the latest time instant of completion of execution of the task, namely, the preset finishing time instant, whereas the online service for example AI online reasoning service runs all the way and does not have the parameter the preset finishing time instant.

It needs to be appreciated that the above cases a), b) and c) are only three cases of the present embodiments. In practical application, it is also feasible to use other user-set policy manners to set the priority of the corresponding task according to an importance degree of the task. Said other policy manners will not be detailed one by one here.

102: inserting a corresponding task into a scheduling queue of a corresponding function according to the priority of the task; tasks in the scheduling queue being arranged in a descending order of priorities;

In the present embodiment, as for an API of each function, or a computing unit in the AI heterogeneous hardware of each function, a corresponding scheduling queue is provided in the task scheduling apparatus of the AI heterogeneous hardware to store the task of the function. Specifically, an application initiates a task execution request through the API of the corresponding function. The API initiates the task execution request to a drive layer via an ioct1 interface. The task scheduling apparatus in the AI heterogeneous hardware in the drive layer obtains the priority of the task according to the attribute information in the task execution request. The drive layer stores a dedicated information quantity for the computing unit of each function, the information quantity comprises a scheduling queue in which are stored a plurality of tasks which all need to schedule a certain computing unit in a plurality of computing units of the function to implement task execution. Furthermore, the plurality of tasks in the scheduling queue are stored in a descending order of priorities.

During insertion of a corresponding task into the scheduling queue of the corresponding function according to the priority of the task, it is feasible to begin to traverse from a head of the scheduling queue. If the priority of a currently-traversed task node is lower than the priority of a task corresponding to a newly-requested task execution request, the newly-requested task is inserted before the currently-traversed task node; and directly inserted at an end of the queue when the end of the queue is traversed.

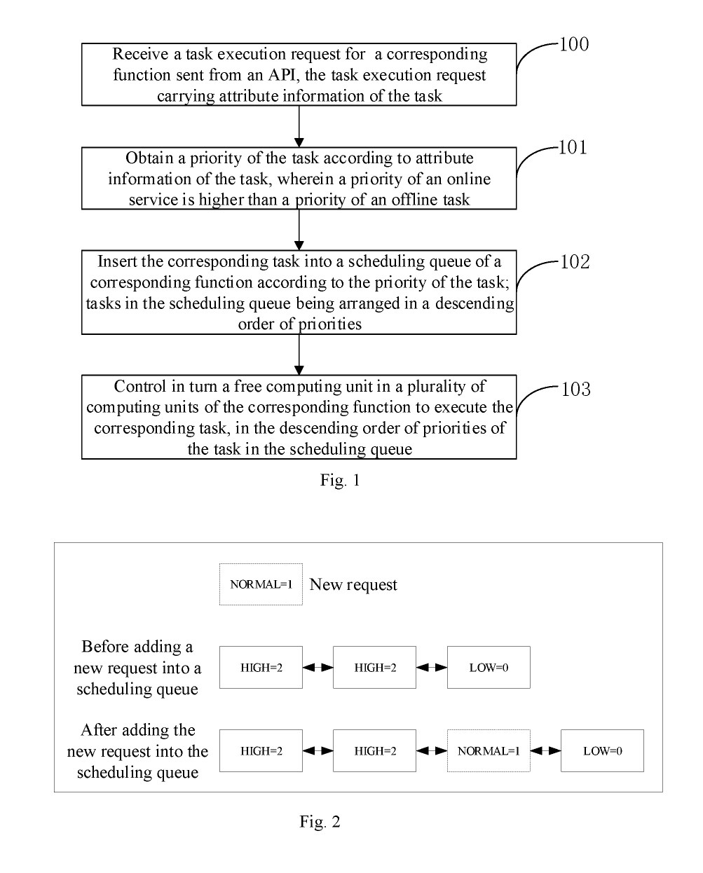

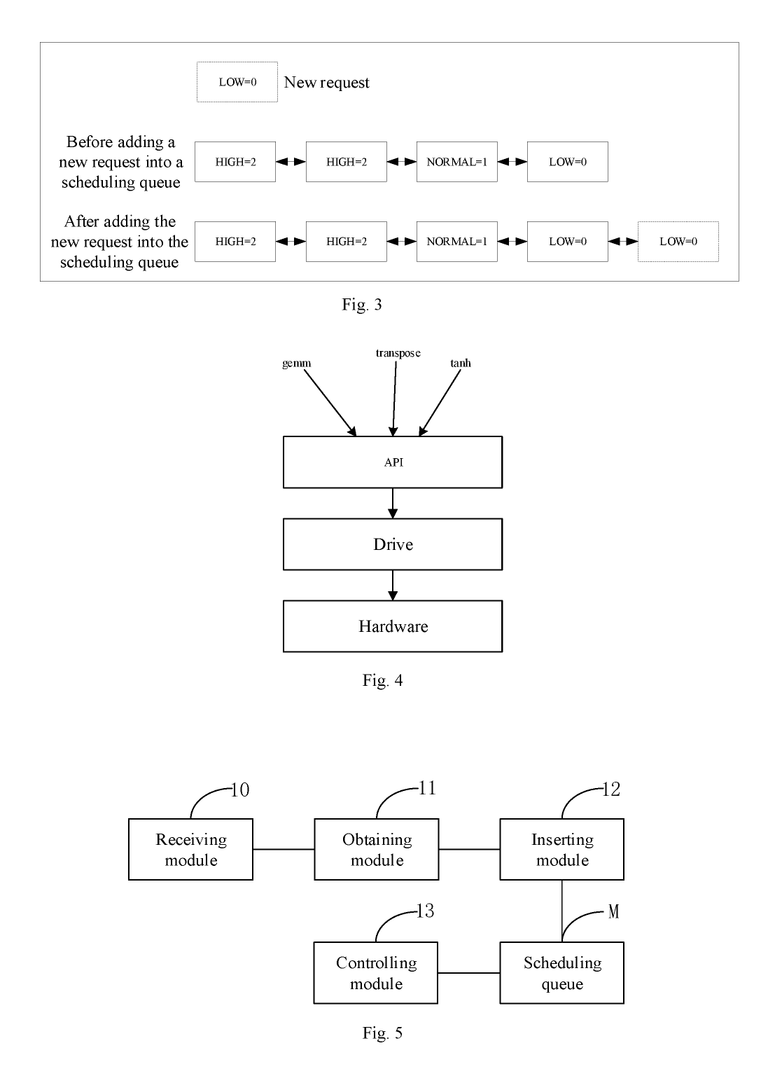

FIG. 2 is a diagram of an example of inserting a task into a scheduling queue of a corresponding function according to the present disclosure. As shown in FIG. 2, the newly-requested task is inserted into the scheduling queue in the insertion manner as stated in the above embodiment. FIG. 3 is a diagram of another example of inserting a task into a scheduling queue of a corresponding function according to the present disclosure. As shown in FIG. 3, the newly-requested task is inserted at the end of the scheduling queue in the insertion manner as stated in the above embodiment.

As shown in FIG. 2 and FIG. 3, upon specific implementation, different priorities are represented with different integer values, for example, HIGH=2, NORMAL=1, and LOW=0. This is helpful to compare priorities and meanwhile facilitate increasing or deleting the number of the priorities.

103: controlling in turn a free computing unit in the plurality of computing units of the corresponding function to execute the corresponding task, in the descending order of priorities of tasks in the scheduling queue.

In practical application, step 102 and step 103 may be performed simultaneously, or step 103 may be performed prior to step 102. For example, after the priority of the newly-requested task is obtained according to step 101, it is feasible to check whether there is a free computing unit in the computing units of the corresponding function in the AI heterogeneous hardware, and if yes, dispatch a task with the highest priority in the scheduling queue so that the computing unit executes this task; meanwhile, when the task is completed or begins to be executed, delete the task from the scheduling queue. If there is not a free computing unit, it is feasible to insert the corresponding task into the scheduling queue of the corresponding function according to step 102. However, a premise for executing this solution is that there is a to-be-executed task in the scheduling queue, otherwise step 102 must be executed first to confirm that there is the to-be-executed task in the scheduling queue, and then execute step 103 to achieve task scheduling.

In practical application, the task scheduling apparatus in AI heterogeneous hardware may operate according to the following process:

(1) Receiving the newly-requested task;

(2) Judging whether there is a free computing unit among the plurality of computing units capable of executing the newly-requested task in the AI heterogeneous hardware, and if yes, executing step (3); or if no, executing step (4);

(3) Sending a task execution command so that the free computing unit executes the task.

When there are tasks in the scheduling queue, once one of the plurality of computing units in the AI heterogeneous hardware corresponding to the scheduling queue is free, the task scheduling apparatus of the AI heterogeneous hardware will send a command of executing the task with the highest priority in turn according to the priorities of tasks in the scheduling queue, so that the computing unit executes the command. Therefore, conversely, once a computing unit is free, this indicates that there is not a to-be-executed task in the scheduling queue of the function. Therefore, at this time it is possible to directly send a command of executing the newly-requested task so that the free computing unit executes the task, without need to store the newly-requested task in the scheduling queue.

(4) Obtaining the priority of the newly-requested task, and, according to the priority of the task, inserting the task into the scheduling queue to sleep, waiting for being waken up.

(5) After it is detected that other computing units complete execution, judging whether there is a to-be-executed task in the scheduling queue, and if yes, executing step (6); if no, when there is no to-be-executed task in the scheduling queue, completing execution and directly returning.

(6) Waking up a first task from the beginning in the scheduling queue, namely, the task with the highest priority; then executing the task in the manner of step (3).

The task scheduling apparatus of the AI heterogeneous hardware may store the newly-requested task sent by the API of any function into the scheduling queue in the manner of the above embodiment, and meanwhile may schedule tasks in turn in a descending order of priorities of tasks of the function in the scheduling queue. In the technical solution of the present embodiment, the priority-based scheduling method enables each computing unit in the AI heterogeneous hardware to preferentially schedule a computing task with a high priority, and meanwhile execute a low-priority task in the absence of high-priority task, thereby substantially improving the resource utilization rate.

According to the task scheduling method of AI heterogeneous hardware of the present embodiment, it is feasible to receive a task execution request for a corresponding function sent from an API, the task execution request carrying attribute information of the task; obtain a priority of a task according to attribute information of the task, wherein a priority of an online service is higher than a priority of an offline task; insert a corresponding task into a scheduling queue of a corresponding function according to the priority of the task; tasks in the scheduling queue being arranged in a descending order of priorities; controlling in turn a free computing unit in the plurality of computing units of the corresponding function to execute the corresponding task, in the descending order of priorities of tasks in the scheduling queue. According to the technical solution of the present embodiment, it is feasible to achieve mixing of the offline model training task and online reasoning service according to the difference of priorities, and it is also feasible to achieve the scheduling of different online reasoning services in the descending order of priorities, and the scheduling of different offline model training tasks also in the descending order of priorities, thereby substantially improving the resource utilization rate.

FIG. 4 is a diagram of architecture of task scheduling processing of AI heterogeneous hardware according to the present disclosure. As shown in FIG. 4, a deep learning processor is taken as an example to introduce an application scenario of the embodiment shown in FIG. 1. Specifically, in the architecture, the API mainly provides some basic interfaces, for example, a matrix multiplication interface gemm, a matrix transpose interface, a hyperbolic function tan h and an activation function interface sigmoid. In the present embodiment, the interface of each function is invoked and carries the attribute information of the task. Correspondingly, the method of the embodiment shown in FIG. 1 is executed in the drive shown in FIG. 4. Specifically, the task scheduling apparatus of AI heterogeneous hardware in the embodiment shown in FIG. 1 may be embedded in the drive, and the drive, according to the method of the embodiment shown in FIG. 1, controls the task to be executed by a computing unit in the plurality of computing units corresponding to the function in the hardware, to implement task scheduling.

FIG. 5 is a structural diagram of Embodiment 1 of a task scheduling apparatus of AI heterogeneous hardware according to the present disclosure. As shown in FIG. 5, the task scheduling apparatus of AI heterogeneous hardware according to the present embodiment may specifically comprise:

a receiving module 10 configured to receive a task execution request for a corresponding function sent from an API, the task execution request carrying attribute information of the task;

an obtaining module 11 configured to obtain a priority of a task according to attribute information of the task received by the receiving module 10, wherein a priority of an online service is higher than a priority of an offline task;

an inserting module 12 configured to insert a corresponding task into a scheduling queue M of a corresponding function according to the priority of the task obtained by the obtaining unit 11; tasks in the scheduling queue M being arranged in a descending order of priorities;

a controlling module 13 configured to, after the insertion processing of the inserting module 12, control in turn a free computing unit in a plurality of computing units of the corresponding function to execute the corresponding task, in the descending order of priorities of tasks in the scheduling queue M;

the scheduling queue M being used to store tasks of the corresponding function in the descending order of priorities.

Principles employed by the task scheduling apparatus of AI heterogeneous hardware of the present embodiment to implement task scheduling of AI heterogeneous hardware with the above modules and the resultant technical effects are the same as those of the above-mentioned method embodiment. For particulars, please refer to the depictions of the aforesaid relevant method embodiment, and no detailed depictions will be presented here.

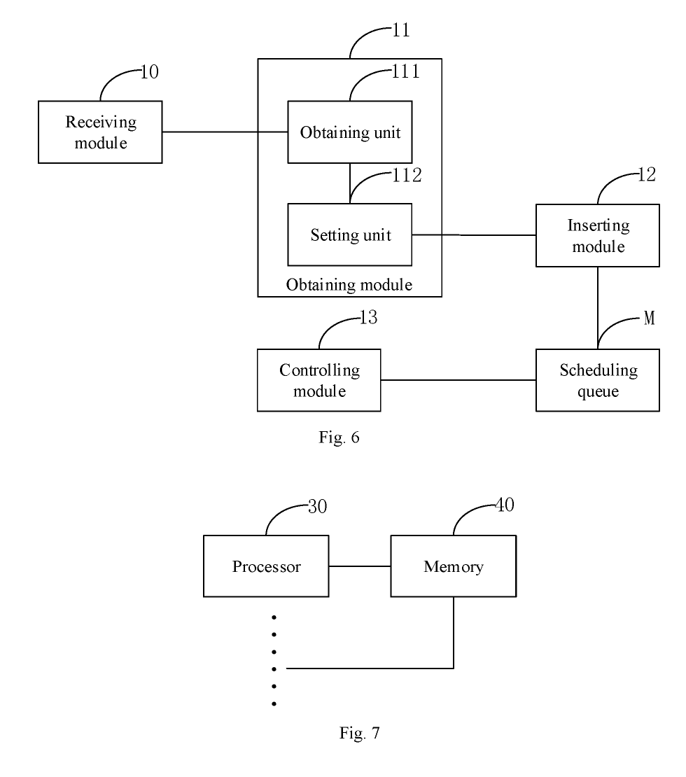

FIG. 6 is a structural diagram of Embodiment 2 of a task scheduling apparatus of AI heterogeneous hardware according to the present disclosure. As shown in FIG. 6, the task scheduling apparatus of the AI heterogeneous hardware of the present embodiment, on the basis of the technical solution of the embodiment shown in FIG. 5, further introduces the technical solutions of the present disclosure in more detail.

In the task scheduling apparatus of the AI heterogeneous hardware of the present embodiment, the attribute information of the task in the task execution request received by the receiving module 10 comprises a priority of the task, and the priority of the task is assigned for the task by a scheduling module at an upper layer of the application program interface.

Or optionally, in the task scheduling apparatus of the AI heterogeneous hardware of the present embodiment, the obtaining module 11 is specifically configured to set a priority for the task according to a pre-stored priority setting policy and the attribute information of the task.

Further optionally, the attribute information of the task in the task execution request received by the receiving module 10 comprises a type of the task which is offline task or online service; the priority setting policy comprises the priority of the task set according to the type of the task;

the obtaining module 11 may specifically comprise:

an obtaining unit 111 configured to obtain a type of the task from the attribute information of the task in the task execution request received by the receiving module 10;

a setting unit 112 configured to set a priority for the task according to the type of the task obtained by the obtaining unit 111, so that the priority of the task corresponding to the online service is higher than the priority of the task corresponding to the offline task.

Or further optionally, if the attribute information of the task in the task execution request received by the receiving module 10 comprises a type of the task and a class in the type, and the type of the task is offline task or online service; the priority setting policy comprises setting the priority for the task according to the type of the task, the class in the type and a high priority class list corresponding to the preset types;

the obtaining unit 111 is specifically configured to obtain the type of the task and the class in the type from the attribute information of the task in the task execution request received by the receiving module 10;

the setting unit 112 is specifically configured to set the priority for the task according to the type of the task, the class in the type obtained by the obtaining unit 111 and the high priority class list corresponding to the preset types; wherein the priority of the task corresponding to the online service is higher than the priority of the task corresponding to the offline task; and, in the same type, the priorities of tasks corresponding to classes in the high priority class list are higher than priorities of tasks corresponding to classes outside the high priority class list.

Or further optionally, if the attribute information of the task in the task execution request received by the receiving module 10 comprises a preset finishing time instant of the task; the priority setting policy comprises setting the priority of the task according to a distance between a preset finishing time instant of the task and a current time instant;

the obtaining unit 111 is specifically configured to obtain the preset finishing time instant of the task from the attribute information of the task in the task execution request received by the receiving module 10;

the setting unit 112 is specifically configured to calculate a time difference between the preset finishing time instant of the task obtained by the obtaining unit 111 and the current time instant; set a priority for the task according to the time difference, so that the priority of the task corresponding to the time difference which is smaller than a first preset time length threshold is higher than the priority of the task corresponding to the time difference which is larger than the first preset time length threshold and smaller than or equal to a second preset time length threshold, and the priority of the task corresponding to the time difference which is larger than the first preset time length threshold and smaller than or equal to the second preset time length threshold is higher than the priority of the task corresponding to the time difference which is larger than the second preset time length threshold.

Correspondingly, the inserting module 12 is configured to insert a corresponding task into the scheduling queue M of a corresponding function according to the priority of the task set by the setting unit 112.

Principles employed by the task scheduling apparatus of AI heterogeneous hardware of the present embodiment to implement task scheduling of AI heterogeneous hardware with the above modules and the resultant technical effects are the same as those of the above-mentioned method embodiment. For particulars, please refer to the depictions of the aforesaid relevant method embodiment, and no detailed depictions will be presented here.

FIG. 7 is a block diagram of an embodiment of a computer device according to the present disclosure. As shown in FIG. 7, the computer device according to the present embodiment comprises: one or more processors 30, and a memory 40 for storing one or more programs, the one or more programs stored in the memory 40, when executed by said one or more processors 30, enabling said one or more processors 30 to implement the task scheduling method of the AI heterogeneous hardware of the embodiment shown in FIG. 1. The embodiment shown in FIG. 7 exemplarily includes a plurality of processors 30.

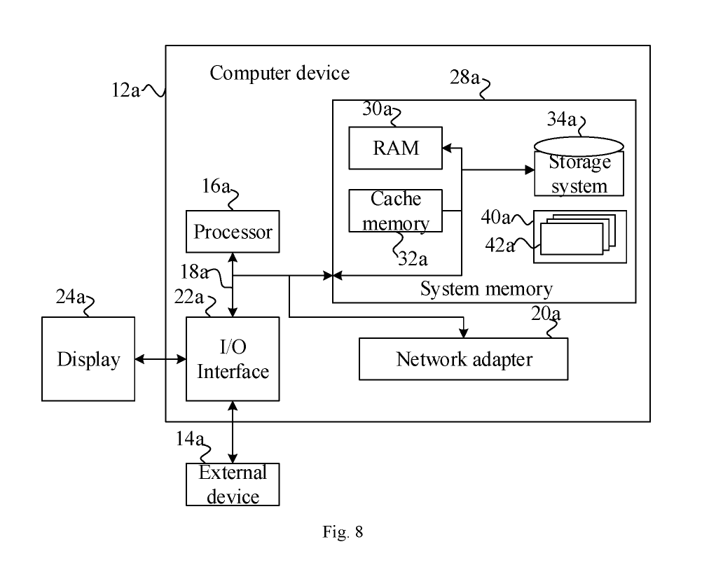

For example, FIG. 8 is an example diagram of a computer device according to an embodiment of the present disclosure. FIG. 8 shows a block diagram of an example computer device 12a adapted to implement an implementation mode of the present disclosure. The computer device 12a shown in FIG. 8 is only an example and should not bring about any limitation to the function and scope of use of the embodiments of the present disclosure.

As shown in FIG. 8, the computer device 12a is shown in the form of a general-purpose computing device. The components of computer device 12a may include, but are not limited to, one or more processors 16a, a system memory 28a, and a bus 18a that couples various system components including the system memory 28a and the processors 16a.

Bus 18a represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer device 12a typically includes a variety of computer system readable media. Such media may be any available media that is accessible by computer device 12a, and it includes both volatile and non-volatile media, removable and non-removable media.

The system memory 28a can include computer system readable media in the form of volatile memory, such as random access memory (RAM) 30a and/or cache memory 32a. Computer device 12a may further include other removable/non-removable, volatile/non-volatile computer system storage media. By way of example only, storage system 34a can be provided for reading from and writing to a non-removable, non-volatile magnetic media (not shown in FIG. 8 and typically called a “hard drive”). Although not shown in FIG. 8, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 18a by one or more data media interfaces. The system memory 28a may include at least one program product having a set (e.g., at least one) of program modules that are configured to carry out the functions of embodiments shown in FIG. 1-FIG. 6 of the present disclosure.

Program/utility 40a, having a set (at least one) of program modules 42a, may be stored in the system memory 28a by way of example, and not limitation, as well as an operating system, one or more disclosure programs, other program modules, and program data. Each of these examples or a certain combination thereof might include an implementation of a networking environment. Program modules 42a generally carry out the functions and/or methodologies of embodiments shown in FIG. 1-FIG. 6 of the present disclosure.

Computer device 12a may also communicate with one or more external devices 14a such as a keyboard, a pointing device, a display 24a, etc.; with one or more devices that enable a user to interact with computer device 12a; and/or with any devices (e.g., network card, modem, etc.) that enable computer device 12a to communicate with one or more other computing devices. Such communication can occur via Input/Output (I/O) interfaces 22a. Still yet, computer device 12a can communicate with one or more networks such as a local area network (LAN), a general wide area network (WAN), and/or a public network (e.g., the Internet) via network adapter 20a. As depicted in FIG. 8, network adapter 20a communicates with the other communication modules of computer device 12a via bus 18a. It should be understood that although not shown, other hardware and/or software modules could be used in conjunction with computer device 12a. Examples, include, but are not limited to: microcode, device drivers, redundant processing units, external disk drive arrays, RAID systems, tape drives, and data archival storage systems, etc.

The processor 16a executes various function applications and data processing by running programs stored in the system memory 28a, for example, implements the task scheduling method of AI heterogeneous hardware in the above embodiments.

The present disclosure further provides a computer readable medium on which a computer program is stored, the program, when executed by the processor, implementing the task scheduling method of AI heterogeneous hardware in the above embodiments.

The computer readable medium of the present embodiment may include RAM 30a, and/or cache memory 32a and/or a storage system 34a in the system memory 28a in the embodiment shown in FIG. 8.

As science and technology develops, a propagation channel of the computer program is no longer limited to tangible medium, and it may also be directly downloaded from the network or obtained in other manners. Therefore, the computer readable medium in the present embodiment may include a tangible medium as well as an intangible medium.

The computer-readable medium of the present embodiment may employ any combinations of one or more computer-readable media. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium can be any tangible medium that include or store programs for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In the embodiments provided by the present disclosure, it should be understood that the revealed system, apparatus and method can be implemented in other ways. For example, the above-described embodiments for the apparatus are only exemplary, e.g., the division of the units is merely logical one, and, in reality, they can be divided in other ways upon implementation.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, Read-Only Memory (ROM), a Random Access Memory (RAM), magnetic disk, or an optical disk.

What are stated above are only preferred embodiments of the present disclosure and not intended to limit the present disclosure. Any modifications, equivalent substitutions and improvements made within the spirit and principle of the present disclosure all should be included in the extent of protection of the present disclosure.

What is claimed is:

1. A task scheduling method of artificial intelligence heterogeneous hardware, wherein the method comprises:
receiving a task execution request for a corresponding function sent from an application program interface, the task execution request carrying attribute information of the task;
obtaining a priority of the task according to attribute information of the task, wherein a priority of an online service is higher than a priority of an offline task;
inserting the corresponding task into a scheduling queue of a corresponding function according to the priority of the task; tasks in the scheduling queue being arranged in a descending order of priorities;
controlling in turn a free computing unit in a plurality of computing units of the corresponding function to execute the corresponding task, in the descending order of priorities of the task in the scheduling queue;

2. The method according to claim 1, wherein the attribute information of the task comprises a priority of the task, and the priority of the task is assigned for the task by a scheduling module at an upper layer of the application program interface.

3. The method according to claim 1, wherein the obtaining a priority of the task according to attribute information of the task specifically comprises:
setting a priority for the task according to a pre-stored priority setting policy and the attribute information of the task.

4. The method according to claim 3, wherein the attribute information of the task comprises a type of the task, and the type of the task is an offline task or online service; the priority setting policy comprises setting the priority of the task according to the type of task;
the setting a priority for the task according to a pre-stored priority setting policy and the attribute information of the task specifically comprises:
obtaining the type of the task from the attribute information of the task;
setting a priority for the task according to the type of the task, so that the priority of the task corresponding to the online service is higher than the priority of the task corresponding to the offline task.

5. The method according to claim 3, wherein the attribute information of the task comprises a type of the task and a class in the type, and the type of the task is an offline task or online service; the priority setting policy comprises setting the priority for the task according to the type of the task, the class in the type and a preset high priority class list corresponding to the preset types;
the setting a priority for the task according to a pre-stored priority setting policy and the attribute information of the task specifically comprises:
obtaining the type of the task and the class in the type from the attribute information of the task;
setting the priority for the task according to the type of the task, the class in the type and the preset high priority class list corresponding to the preset types; wherein the priority of the task corresponding to the online service is higher than the priority of the task corresponding to the offline task; and, in the same type, the priorities of tasks corresponding to classes in the high priority class list are higher than priorities of tasks corresponding to classes outside the high priority class list.

6. The method according to claim 3, wherein the attribute information of the task comprises a preset finishing time instant of the task; the priority setting policy comprises setting the priority of the task according to a distance between the preset finishing time instant of the task and a current time instant;
the setting a priority for the task according to a pre-stored priority setting policy and the attribute information of the task specifically comprises:
obtaining the preset finishing time instant of the task from the attribute information of the task;
calculating a time difference between the preset finishing time instant of the task and the current time instant;
setting a priority for the task according to the time difference, so that the priority of the task corresponding to the time difference which is smaller than a first preset time length threshold is higher than the priority of the task corresponding to the time difference which is larger than the first preset time length threshold and smaller than or equal to a second preset time length threshold, and the priority of the task corresponding to the time difference which is larger than the first preset time length threshold and smaller than or equal to the second preset time length threshold is higher than the priority of the task corresponding to the time difference which is larger than the second preset time length threshold.

7. A computer device, wherein the device comprises:
one or more processors,
a memory for storing one or more programs,
the one or more programs, when executed by said one or more processors, enable said one or more processors to implement a task scheduling method of artificial intelligence heterogeneous hardware, wherein the method comprises:
receiving a task execution request for a corresponding function sent from an application program interface, the task execution request carrying attribute information of the task;
obtaining a priority of the task according to attribute information of the task, wherein a priority of an online service is higher than a priority of an offline task;
inserting the corresponding task into a scheduling queue of a corresponding function according to the priority of the task; tasks in the scheduling queue being arranged in a descending order of priorities;
controlling in turn a free computing unit in a plurality of computing units of the corresponding function to execute the corresponding task, in the descending order of priorities of the task in the scheduling queue;

8. The computer device according to claim 7, wherein the attribute information of the task comprises a priority of the task, and the priority of the task is assigned for the task by a scheduling module at an upper layer of the application program interface.

9. The computer device according to claim 7, wherein the obtaining a priority of the task according to attribute information of the task specifically comprises:
setting a priority for the task according to a pre-stored priority setting policy and the attribute information of the task.

10. The computer device according to claim 9, wherein the attribute information of the task comprises a type of the task, and the type of the task is an offline task or online service; the priority setting policy comprises setting the priority of the task according to the type of task;
the setting a priority for the task according to a pre-stored priority setting policy and the attribute information of the task specifically comprises:
obtaining the type of the task from the attribute information of the task;
setting a priority for the task according to the type of the task, so that the priority of the task corresponding to the online service is higher than the priority of the task corresponding to the offline task.

11. The computer device according to claim 9, wherein the attribute information of the task comprises a type of the task and a class in the type, and the type of the task is an offline task or online service; the priority setting policy comprises setting the priority for the task according to the type of the task, the class in the type and a preset high priority class list corresponding to the preset types;
the setting a priority for the task according to a pre-stored priority setting policy and the attribute information of the task specifically comprises:
obtaining the type of the task and the class in the type from the attribute information of the task;
setting the priority for the task according to the type of the task, the class in the type and the preset high priority class list corresponding to the preset types; wherein the priority of the task corresponding to the online service is higher than the priority of the task corresponding to the offline task; and, in the same type, the priorities of tasks corresponding to classes in the high priority class list are higher than priorities of tasks corresponding to classes outside the high priority class list.

12. The computer device according to claim 9, wherein the attribute information of the task comprises a preset finishing time instant of the task; the priority setting policy comprises setting the priority of the task according to a distance between the preset finishing time instant of the task and a current time instant;
the setting a priority for the task according to a pre-stored priority setting policy and the attribute information of the task specifically comprises:
obtaining the preset finishing time instant of the task from the attribute information of the task;
calculating a time difference between the preset finishing time instant of the task and the current time instant;
setting a priority for the task according to the time difference, so that the priority of the task corresponding to the time difference which is smaller than a first preset time length threshold is higher than the priority of the task corresponding to the time difference which is larger than the first preset time length threshold and smaller than or equal to a second preset time length threshold, and the priority of the task corresponding to the time difference which is larger than the first preset time length threshold and smaller than or equal to the second preset time length threshold is higher than the priority of the task corresponding to the time difference which is larger than the second preset time length threshold.

13. A computer readable medium on which a computer program is stored, wherein the program, when executed by the processor, implements a task scheduling method of artificial intelligence heterogeneous hardware, wherein the method comprises:
receiving a task execution request for a corresponding function sent from an application program interface, the task execution request carrying attribute information of the task;
obtaining a priority of the task according to attribute information of the task, wherein a priority of an online service is higher than a priority of an offline task;
inserting the corresponding task into a scheduling queue of a corresponding function according to the priority of the task; tasks in the scheduling queue being arranged in a descending order of priorities;
controlling in turn a free computing unit in a plurality of computing units of the corresponding function to execute the corresponding task, in the descending order of priorities of the task in the scheduling queue;

14. The computer readable medium according to claim 13, wherein the attribute information of the task comprises a priority of the task, and the priority of the task is assigned for the task by a scheduling module at an upper layer of the application program interface.

15. The computer readable medium according to claim 13, wherein the obtaining a priority of the task according to attribute information of the task specifically comprises:
setting a priority for the task according to a pre-stored priority setting policy and the attribute information of the task.

16. The computer readable medium according to claim 15, wherein the attribute information of the task comprises a type of the task, and the type of the task is an offline task or online service; the priority setting policy comprises setting the priority of the task according to the type of task;
the setting a priority for the task according to a pre-stored priority setting policy and the attribute information of the task specifically comprises:
obtaining the type of the task from the attribute information of the task;
setting a priority for the task according to the type of the task, so that the priority of the task corresponding to the online service is higher than the priority of the task corresponding to the offline task.

17. The computer readable medium according to claim 15, wherein the attribute information of the task comprises a type of the task and a class in the type, and the type of the task is an offline task or online service; the priority setting policy comprises setting the priority for the task according to the type of the task, the class in the type and a preset high priority class list corresponding to the preset types;
the setting a priority for the task according to a pre-stored priority setting policy and the attribute information of the task specifically comprises:
obtaining the type of the task and the class in the type from the attribute information of the task;
setting the priority for the task according to the type of the task, the class in the type and the preset high priority class list corresponding to the preset types; wherein the priority of the task corresponding to the online service is higher than the priority of the task corresponding to the offline task; and, in the same type, the priorities of tasks corresponding to classes in the high priority class list are higher than priorities of tasks corresponding to classes outside the high priority class list.

18. The computer readable medium according to claim 15, wherein the attribute information of the task comprises a preset finishing time instant of the task; the priority setting policy comprises setting the priority of the task according to a distance between the preset finishing time instant of the task and a current time instant;
the setting a priority for the task according to a pre-stored priority setting policy and the attribute information of the task specifically comprises:
obtaining the preset finishing time instant of the task from the attribute information of the task;
calculating a time difference between the preset finishing time instant of the task and the current time instant;
setting a priority for the task according to the time difference, so that the priority of the task corresponding to the time difference which is smaller than a first preset time length threshold is higher than the priority of the task corresponding to the time difference which is larger than the first preset time length threshold and smaller than or equal to a second preset time length threshold, and the priority of the task corresponding to the time difference which is larger than the first preset time length threshold and smaller than or equal to the second preset time length threshold is higher than the priority of the task corresponding to the time difference which is larger than the second preset time length threshold.
